(19) United States
(12) Patent Application Publication
(10) Pub. No.: US 2006/0106708 A1
(43) Pub. Date: May 18, 2006

(54) System and method for processing matched trades

(76) Inventors: Bassel M. Abushaban, Tinley Park, IL (US); James G. Bennett, Glen Ellyn, IL (US); Mike B. Boyle, Naperville, IL (US); Bryan T. Durkin, Orland Park, IL (US); Ryan S. Eavy, Chicago, IL (US); William R. Gillmore, Chicago, IL (US); Scott R. Kaufman, Winnetka, IL (US); Denise M. Schaller, Elmhurst, IL (US)

Correspondence Address: MCCRACKEN & FRANK LLP, 200 W. ADAMS STREET, SUITE 2150, CHICAGO, IL, 60606, US

(21) Appl. No.: 10/992,061

(22) Filed: Nov. 18, 2004

(51) Int. Cl. G06Q 40/00

(52) U.S. Cl. 705/37

(57) ABSTRACT

A system for reporting and processing a matched trade from a market in response to orders submitted by traders includes a management subsystem for developing configuration data regarding products that are to be traded and traders who are authorized to trade. The system further includes a trade processing subsystem for receiving first data representing the matched trade and which processes the first data to create second data representing a processed trade wherein the second data are transmitted to a first recipient and a reporting subsystem for receiving market information and which processes the market information and transmits the processed market information to a second recipient. Methods of reporting and/or processing are also disclosed.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to trading systems, and more particularly, to a system for the processing and reporting of information regarding trades undertaken on one or more exchanges.

2. Description of the Background of the Invention

Traditional futures and options exchanges provide a location for buyers and sellers to meet and, through an open outcry auction system, negotiate prices for specific futures and options contracts. In addition, the exchanges formulate rules for trading and supervise trading practices. Although only members of the exchange have the privilege of trading on the exchange floor, theoretically any person can have indirect access to the exchange through various brokers.

As new trading technologies have emerged, this traditional trading forum has been supplemented and, at some exchanges, even replaced. Early technological advancements facilitated the extension of overnight trading sessions, so that major contracts could be traded even when the pits are closed. More recently, electronic trading systems have been created to completely replace the traditional trading forums. In addition, new products have been designed that are traded only on electronic trading systems.

Electronic trading systems include powerful and sophisticated computers that match market bids and offers in accordance with open outcry trading standards. These systems potentially allow a trader from anywhere in the world to buy or sell any product that the trader is authorized to trade in. In addition to overcoming these access constraints, electronic trading has enabled lower operating costs and has allowed for enhanced monitoring of trading activity to ensure conformance with regulations.

To increase efficiency, many electronic exchange systems have used third parties to perform tasks that were traditionally performed by the exchanges, such as tasks performed by trading hosts, clearing, and associated reporting. In addition to the clearing function, the clearinghouse is responsible for providing settlement. Specifically, the clearinghouse receives records of all of the trades executed during a respective exchange session, matches or reconciles contracts bought and sold, and settles traders' accounts to the market before the next trading session begins.

Baeker et al. U.S. Publication No. 2001/0049649 discloses a linking system for connecting at least one trading system and a clearing system. The system receives transactional messages from a trading system, packs the messages, and sends same to a queue, where the messages are later directed to a clearing interface. The clearing interface translates the transactional messages from an original format to a format required by the clearing system.

A system and method for handling a trade between execution and settlement is disclosed in Kuhn et al. U.S. Publication No. 2004/0128223. The system includes a data input unit for receiving trade execution data relating to an executed trade, a data processing unit for creating settlement instructions based on the execution data, and a data output unit for transmitting the settlement instructions.

Wagner U.S. Pat. No. 4,903,201 discloses an automated futures trading exchange wherein bids to purchase or offers to sell are made by members through remote terminals. A central computer of the trading system receives and automatically matches offers and bids from remote terminals. Thereafter, a clearing system receives data from the central computer and clears all trades based upon exchange rules. A compliance system also receives data from the central computer and checks the data to determine whether the data meet predetermined limits or requirements established for each exchange member.

A foreign exchange trading system is disclosed in Reuter et al. U.S. Publication No. 2002/0049666. The system receives and transmits trading data over a communications network and acts as a relay between clients and dealers. For example, market data (such as pricing information) originating with dealers are transmitted to the system wherein the data are aggregated prior to transmission to client network access devices for viewing by clients. Thereafter, clients may send information requests, bids, offers, etc. through the system to the dealer and the dealer can respond through the system by sending pricing information, quotes, etc.

A system and method for commodity trading is disclosed in Lerner U.S. Publication No. 2002/0120555. The system includes a computer having a communication interface that provides a two-way communication coupling to a network link connected to a local network. The network link typically provides data communication through one or more networks to other data devices, such as a host computer. The system aggregates market information from sources such as news feeds, price quote feeds, commodity brokers and traders, futures brokers, financial providers, and institutions, etc. Thereafter, the system provides the information to market participants who can conduct transactions.

Satow et al. U.S. Publication No. 2003/0050888 discloses a real-time after-hours stock trading system. The system acts as a hub connecting users from numerous brokerage firms and executes trades by matching buy and sell trade orders from such users. The system simultaneously publishes market information to users while receiving and executing orders. The system receives market information from a database that is updated in real-time and thereafter sends the market information over the Internet to users.

A futures trading exchange is disclosed in Ascher et al. U.S. Publication No. 2004/0088242. The exchange includes a distributed network over which futures contracts are traded. Clients communicate through a network with a trade matching system 28, wherein the trading matching system 28 provides a central order processing facility for order matching, order entry and storage, price reporting and dissemination, order and trade display, depth of market, and/or margin calculation. After close of trading, all required trade information is sent to a clearinghouse for clearance. Trade information is also sent on a predetermined basis to a regulator that performs a regulatory and compliance function, such as audit-trail monitoring.

### SUMMARY OF THE INVENTION

According to one aspect of the present invention, a system for reporting and processing a matched trade from a market in response to orders submitted by traders includes a management subsystem for developing configuration data regarding products that are to be traded and traders who are authorized to trade. The system further includes a trade processing subsystem for receiving first data representing the matched trade and which processes the first data to create second data representing a processed trade wherein the second data are transmitted to a first recipient and a reporting subsystem for receiving market information and which processes the market information and transmits the processed market information to a second recipient.

According to a further aspect of the preset invention, a computer implemented system for reporting and processing matched trades from a market in response to orders submitted by traders includes a trade processing subsystem having at least one trade processor that converts data representing matched trades into clearing data wherein the clearing data are transmitted to a clearing bus wherein the clearing data are transmitted to at least one of a plurality of clearinghouses. The system further includes a reporting subsystem for receiving market information and which processes the market information and transmits the processed market information to a broadcaster.

According to another aspect of the present invention, a computer implemented method of reporting and processing matched trades from a market in response to orders submitted by traders includes the steps of converting data representing matched trades into clearing data wherein the clearing data, enabling transmission of clearing data to each of a plurality of clearinghouses, and transmitting the clearing data to at least one of the clearinghouses. In addition, data are received representing market information, the market information is processed to obtain market data, and the processed market information is transmitted to a broadcaster.

According to yet another aspect of the present invention, a computer implemented method for processing and reporting information created in response to orders submitted to a market includes the steps of receiving trading data in a first format representing matched trades, processing the trading data to develop clearing data in a second format representing the matched trades, and transmitting the clearing data to at least one of a plurality of clearinghouses. Market depth data are developed and transmitted to a data distribution module and market update data are developed from at least one of an electronic market and an open outcry market. The market update data are transmitted to the data distribution module and the data distribution module is caused to send processed market data to a broadcaster responsive to receipt of the market depth data and the market update data.

In accordance with a still further aspect of the present invention, a computer implemented method of processing matched trade data includes the steps of receiving matched trade data representing a matched trade, converting the matched trade data into a clearing message wherein the clearing message includes a clearinghouse code, enabling communication with each of a plurality of clearinghouses, and sending the clearing message to at least a selected one of the clearinghouses based upon the clearinghouse code.

According to another aspect of the present invention, a system for processing matched trade data includes means for receiving the matched trade data, means for converting the matched trade data into a clearing message, and means for sending the clearing message to one of multiple clearinghouses.

### BRIEF DESCRIPTION OF THE DRAWINGS

FIG. 1 is a block diagram of a trade processing and reporting system in accordance with the present invention;

FIG. 2 is a detailed block diagram of a market configuration subsystem forming a part of the system of FIG. 1;

FIG. 3 is a detailed block diagram of a trade processing subsystem forming another part of the system of FIG. 1;

FIG. 3A is a flowchart illustrating how trade data is processed by the trade processing subsystem of FIG. 3;

FIG. 4 is a detailed block diagram of a quote vendor subsystem forming yet another part of the system of FIG. 1;

FIG. 5 is a flowchart illustrating how market data from trade matching is processed by the quote vendor subsystem of FIG. 4; and

FIG. 6 is a flowchart illustrating how market data from open-outcry is processed by the quote vendor subsystem of FIG. 4.

### DETAILED DESCRIPTION OF THE DRAWINGS

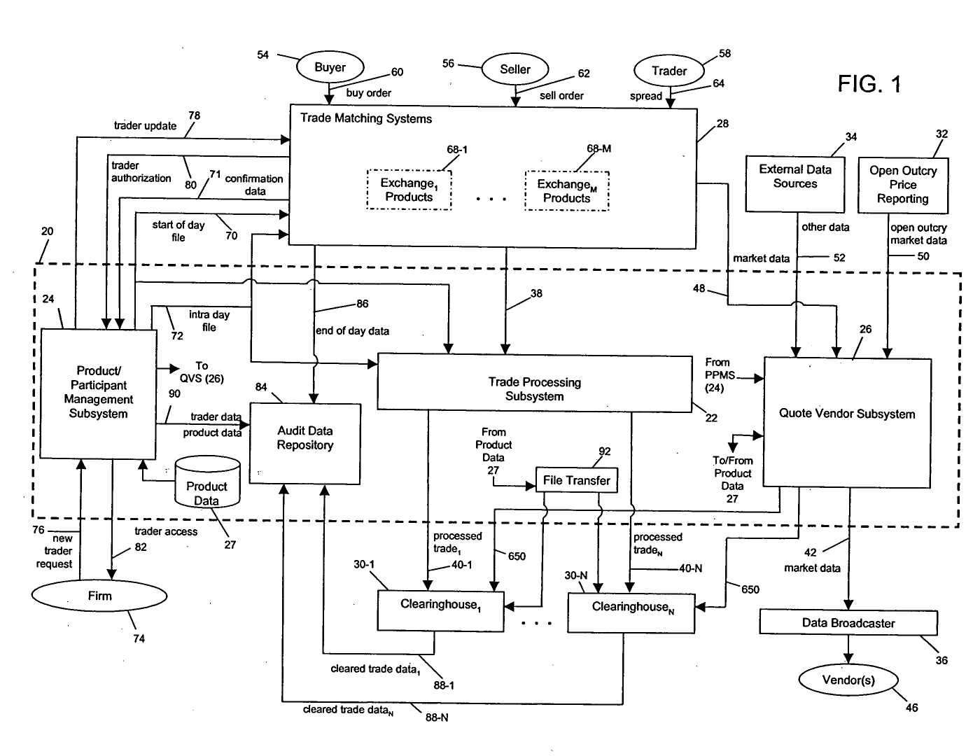

FIG. 1 depicts a logical block diagram of a trade processing and reporting system 20 according to the present invention. Specifically, the trade processing and reporting system 20 includes a trade processing subsystem 22, a product/participant management subsystem (PPMS) 24, a quote vendor subsystem 26, and product database 27. The trade processing and reporting system 20 of the present invention interfaces with other systems operated by other parties as shown in FIG. 1, specifically one or more trade matching systems 28 operated by one or more associated exchanges, respectively, N clearinghouses 30-1 through 30-N (where N is an integer), an open outcry price reporting system 32, one or more external data sources 34, and one or more data broadcaster(s) 36. Each trade matching system 28 includes at least a trading host and additional functionality to manage traders and trading activity. Preferably, a single trade matching system 28 communicates with the trade processing and reporting system 20. Also preferably, the trade matching system 28 is the LIFFE CONNECT® system provided by LIFFE Administration and Management of London, United Kingdom.

The trade processing and reporting system 20 receives data 38 representing a matched trade from the trade matching system 28, processes the matched trade to create a processed trade, and transmits data 40-1 through 40-N representing a processed trade to one of the clearinghouses 30-1 through 30-N. In addition, the trade processing and reporting system 20 may feed real-time market data 42 to one or more of the data broadcasters 36, who in turn relay the market data to its (their) subscribers (typically data vendors) 46. The real-time market data 42 include data about the trading activity in the particular trade matching system 28 on which the trade was executed (48), trading data 50 obtained from an open-outcry price reporting system 32 that reports market data from an open-outcry (i.e., non-electronic) portion of the exchange, and data 52 from other sources 34 that may be relevant to the markets in one or more products.

As examples, a buyer 54, a seller 56, and a generic user 58 may submit data 60, 62, and 64 representing a buy order, a sell order, and a spread, respectively, to the trade matching system 28. The buy order and the sell order are orders to respectively buy or sell a product with particular terms (e.g., delivery month, price, quantity, etc.). The spread is a single order submitted by the user 58 that includes multiple buy and sell components. Each buy or sell component of the spread is called a “leg.”

The trade matching system 28 monitors data 60, 62, and 64 submitted by the buyer 54, the seller 56, and the user 58, respectively, in order to identify a buy order (or a buy leg of a spread) and a sell order (or a sell leg of a spread) wherein both orders are for the same product, and have compatible terms. The buy order and sell order identified in this manner become two halves of a matched trade. In the preferred embodiment, the trade matching system 28 encodes the matched trade into data conforming to a LIFFE CONNECT® specific XML schema and transmits the data 38 representing the matched trade to the trade processing subsystem 22. The trade processing subsystem 22 extracts the trade information from the transmitted data 38, processes the information comprising the matched trade in a manner described below to create a processed trade, and transmits one or more sets of data 40-1 through 40-N representing the processed trade to one of the clearinghouses 30-1 through 30-N. In the preferred embodiment the processed trade is sent to one of the clearinghouses 30-1 through 30-N. Alternatively, the processed trade may be transmitted to more than one of the clearinghouses 30-1 through 30-N.

Spreads also have markets that trade both legs of the spread as a single product. In this case, a buyer 54 submits a buy order 60 to buy a spread and a seller 62 submits a sell order 62 to sell a spread. By convention, an order to buy a spread means that the order specifies buying the front leg of the spread and selling the back leg of the spread. Similarly, an order to sell a spread means that the order specifies selling the front leg of the spread and buying the back leg of the spread. Furthermore, spreads are denoted by the differential between the price of the front leg of the spread and the price of the back leg of the spread. The trade matching system attempts to match orders to buy and sell a spread. If the trade matching system finds a match, the buy and sell components required to match each leg of the spread are encoded into a matched trade, and data 38 representing the matched trade are transmitted to the trade processing subsystem. As an example, consider that the trade matching system 28 matches a buy order submitted by a buyer identified as “ABC” to buy a September/December spread for 5,000 bushels of beans with a differential of $0.25 (i.e., the buyer “ABC” is buying September beans for $0.25 more that s/he is selling December beans) with a sell order submitted by seller “DEF” to sell a September/December spread for 5,000 bushels of beans at with a differential of $0.25. In this scenario, the trade matching system 28 generates and transmits data 38 representing 2 matched trades. Data 38 are transmitted representing the matched trade for 5,000 September beans bought by “ABC” and sold by “DEF” for $5/bushel and further data 38 are transmitted representing the matched trade for 5,000 December beans sold by “ABC” and bought by “DEF” for $5/bushel.

The trade matching system may also use individual buy and sell orders to satisfy the legs of a spread. In this case a user 58 submits data 64 representing a spread to the trade matching system 28 for a spread, then the trade matching system 28 attempts to match each leg of the spread with other buy orders and sell orders, or buy and sell legs of other spreads. The trade matching system 28 encodes each leg of the spread and the other buy or sell order(s) that was (were) matched with the leg as a separate matched trade and the data 38 representing the matched trade are transmitted to the trade processing subsystem 22. For example, consider a March/May spread for 15,000 bushels of wheat with a differential of $0.25. To match the spread in the foregoing example, the trade matching system 28 may match the buy order of the spread with an order to sell 10,000 bushels of March wheat at $2/bushel submitted by a first trader and another order to sell 5,000 bushels of March wheat at $2/bushel submitted by a second trader. The sell order of the spread may be matched with an order to buy 15,000 bushels of May wheat for $2.25/bushel from a third trader. In this scenario, the trade matching system 28 generates and transmits three sets of data 38 representing the two matched trades for the buy leg of the spread and one matched trade for the sell leg of the spread.

The trade processing subsystem creates and transmits data 40 representing a processed trade as data 38 representing each matched trade are received from the trade matching system 28. In the case of a spread referred to hereinafter as a SLEDS (Single Line Entry of Differential Spread) trade, the trade processing subsystem may aggregate all of the matched trades related to the spread and create data 40 representing the SLEDS trade as a whole. Whether a matched spread is reported to a clearinghouse 30 as a plurality of processed trades or as a single SLEDS trade depends on the characteristics of the spread and business rules established between the exchange and the clearinghouse 30. Specifically, if a spread is to be reported as a SLEDS trade, the trade processing subsystem 22 accumulates matched trades sent by the trade matching system 28 for each leg of a spread. When the matched trades for all of the legs of the spread are received, the trade processing subsystem 22 combines data identifying and otherwise specifying the matched trades, translates the data according to business rules defined for the products being traded and transmits resulting data 40-1 through 40-N to one (or more) of the clearinghouses 30-1 through 30-N. Other data representing processed trades (including other matched buy and sell orders, as well as other spreads and buy/sell orders matching the legs of the other spreads) are created in a similar fashion and transmitted to one or more of the clearinghouses 30-1 through 30-N. The encoding formats of the data 40 conform to the data interchange requirements established between the trade processing subsystem 22 and the clearinghouse(s) 30-1 through 30-N that is (are) to receive the data.

The trade matching system 28 supports trading of products from a plurality of M markets including Exchange₁ 68-1 through Exchange_{M} 68-M (where M is an integer) so that users, including users 54, 56, and 58, can submit orders for products traded on any or all of the supported markets. Typically, (although not necessarily always) each market is associated with only one of the clearinghouses 30-1 through 30-N (hence M=N) and data 40-1 through 40-N representing processed trades for products traded on one of the markets 68-1 through 68-M are sent only to the one of the clearinghouses 30-1 through 30-N associated with that market. Alternatively, one or more clearinghouses 30-1 through 30-N may clear trades for more than one of the markets 68-1 through 68-M (i.e., M<N). For example, referring again to FIG. 1, the trade processing subsystem 22 may send data 40-1 representing a processed trade in response to data 38 representing a matched trade for products traded on Exchange₁ 68-1 to Clearinghouse₁ 40-1 for clearing. The trade processing subsystem 22 may further send data 40-1 through 40-M representing a processed trade in response to data 38 representing a matched trade for a product traded on any of the remaining exchanges, for example Exchange_{M} 68-M, to any one of the N clearinghouses, for example, the clearinghouse 30-N. The trade processing subsystem 22 is responsible for correctly routing data 40-1 through 40-N representing a processed order to one of the appropriate clearinghouses 30-1 through 30-N.

The PPMS 24 transmits a start-of-day file 70 at the beginning of each trading day, where a trading day represents the duration between a start time and an end time. The trading day may comprise multiple trading sessions for multiple products each having their own start and end times. The trade matching system validates and loads the start-of-day file 70. The trade matching system 28 sends data 71 notifying the PPMS 24 if the start-of-day file 70 was valid and successfully loaded or if the start-of-day file 70 contained an error. Upon receiving a notification that the start-of-day file 70 was successfully loaded, the PPMS 24 makes the start-of-day file 70 available to the trade processing subsystem 22. If an error notification is received then manual intervention is undertaken to ensure that a corrected version of the start-of-day file 70 is sent to the trade matching system 28, as noted in greater detail below. The start-of-day file 70 for a particular day identifies the products that are eligible for trading and the traders who are authorized to trade on the trade matching system 28 during the sessions on that day. The PPMS 24 may also send an intra-day file 72 to both the trade matching system 28 and the trade processing subsystem 22 during a trading day to update product or trader information previously sent in the start-of-day file 70. Examples of information that may be updated using the intra-day file 72 are new price ranges for one or more traded products.

An administrator at a firm 74 who has the appropriate privileges may authorize a new user by issuing data 76 specifying the new user by completing an electronic form provided through a web browser that either forms a part of or is in communication with the PPMS 24. The PPMS 24 transmits the new user information as data 78 representing a user update to the trade matching system 28. The trade matching system 28 processes the user update and transmits user authorization data 80 to the PPMS 24. Upon receipt of the user authorization data 80, the PPMS 24 updates its internal databases and transmits user access data 82 to the firm 74 that requested authorization of the new user. All of the processing and communications to authorize the new user is automated, except for the interaction between the administrator 74 and the web browser.

Throughout the trading session, the trade matching system 28 transmits real-time market data 48 to a quote vendor subsystem 26. The transmitted market data 48 include market updates and market depth changes, settlements, indicative prices and deltas, volatilities and interest rates, and messages such as updates on the state of various electronic markets. In addition to market data 48 regarding the trade matching system 28, the quote vendor subsystem 26 broadcasts data 42 assembled from open-outcry market data 50 from the open-outcry (i.e., non-electronic) market reporting system 32 and other data 52 from external data sources 34 (e.g., news and weather data) to the data broadcaster 36. The data broadcaster 36 in turn broadcasts the data 42 to vendors 46 who have contracted with the data broadcaster 36 to receive data over a multicast link 44.

An audit data repository 84 receives end-of-day data 86 from the trade matching system 28. The end-of-day data comprise information regarding events that transpired on the trade matching system 28 during the trading day and include every user login and logout, all orders, every trade matched, and all settlement prices. In addition, the audit data repository 84 receives cleared trade data 88-1 through 88-N from one or more of the clearinghouses 30-1 through 30-N at the end of each trading session. The cleared trade data 88-1 through 88-N include information regarding each trade cleared by the clearinghouse. In addition, the audit data repository 84 receives trader and product data 90 from the market configuration subsystem 24 at the end of each trading day regarding traders and products that were eligible for trading during the completed trading day. The audit data repository 84 may also receive data regarding non-electronic (i.e., open outcry) and other trade related information. The audit data repository 84 makes all of the data it receives available to auditing and surveillance systems that identify transactions, patterns, or anomalies that indicate possible violations of exchange rules and/or regulations.

The product database 27 is used as a repository for operational data by various subsystems across the processing and reporting system. In addition, the clearinghouses 30-1 through 30-N use a file transfer process 92 to access product information stored in the product database 27. Such product information includes identification information and price (open, high, low, and close) information.

A preferred embodiment implements transmission of messages between the trade matching system 28 and the trade processing and reporting system 20, and between the trade processing and reporting system 20 and the clearinghouses 30-1 through 30-N using communications middleware provided by MQ Server from IBM Corporation of Armonk, N.Y., as part of its WebSphere product. Additional communications services are implemented through application programmer interfaces defined by LIFFE Administration and Management for use with the LIFFE CONNECT® trade matching system.

The physical implementation of the trade processing and reporting system 20 spans a plurality of servers and is scalable using methods that would be apparent to one skilled in the art. The software implementation of the trade processing and reporting system 20 is designed as a collection of Enterprise Java Beans running on a J2EE compliant application server provided by the WebLogic Platform™ from BEA Systems, Incorporated of San Jose, Calif.

It would be apparent to one skilled in the art to implement the present invention using other communications and application development platforms, as appropriate.

### I. Product/Participant Management Subsystem

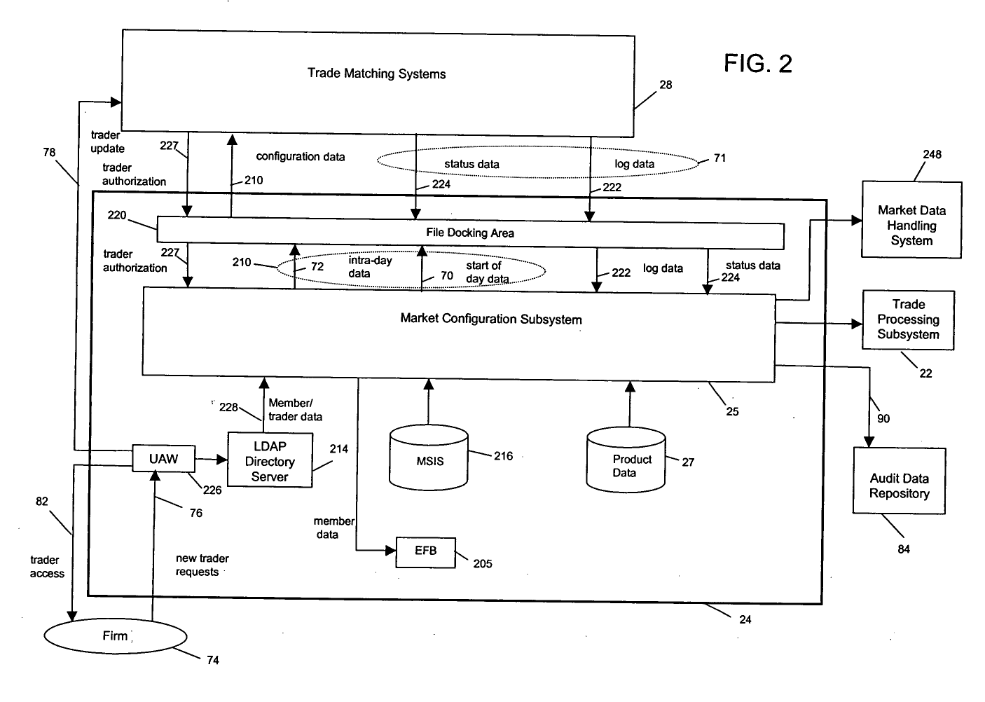

Referring to FIG. 2, an embodiment of the PPMS 24 is depicted. The PPMS 24 provides participant (i.e., trader and/or member) data and product data to the trade matching system 28, the trade processing subsystem 22, the audit data handler 84, and the exchange fee billing system 205.

### Start of Day

As noted above, the PPMS 24 transmits the start-of-day file 70 and the intra-day file 72 to the trade matching system 28 at certain times as specified by an authorized user. Specifically, a market configuration subsystem (MCS) 25 of the PPMS 24 creates and transmits the start-of-day 70 and intra-day file 72. For the sake of simplicity, the files 70 and 72 are hereinafter referred to as configuration data 210. The trade matching system 28 uses the configuration data 210 to initialize internal processes with information regarding the products that will be traded and the traders who will be allowed to submit orders during an associated trading day. Specifically, the MCS 25 retrieves product data from a product database 27, trader and member data from an LDAP directory server 214 to create the configuration data. The MCS 25 thereafter transfers one or more files comprising the configuration data to an MCS file docking area 220. The MCS 25 stores the configuration data 210 preferably, although not necessarily, as a single transfer data file in the MCS docking area 220. The transfer data file(s) may be compressed and/or archived before transmission. In addition, each transfer data file preferably includes an indication in the name thereof regarding the date of the associated trading day.

Secure copy protocol and secure file transfer protocol software are used to transmit the configuration data 210 to the electronic trading system 28. Preferably, the software utilized is JSch provided by JCraft of Sendai, Japan. Also preferably, the secure copy protocol and secure file transfer protocol software encrypts the configuration data 210, as well as the data 71 comprising log data 222 and status data 224 transmitted by the trade matching system 28 to the MCS 25 in order to minimize the risks of eavesdropping, connection hijacking, and other network-level attacks.

The trade matching system 28 polls the MCS docking area 220 for the presence of any transfer data file(s) waiting to be transmitted and initiates the transmission of any files found. After the transmission of the data 210 is complete, the trade matching system 28 decompresses the data (if necessary), and attempts to load the data into the internal databases thereof. The trade matching system 28 thereafter transmits the status data 224 to the MCS docking area 220 that contain a completion message indicating the success or failure of the transmission and the success or failure of the database loading process. The trade matching system 28 also transmits the log data 222 to the MCS docking area 220 that include details of any errors that were encountered during either of the transmission or loading processes.

If an error occurs during the transmission of one of the configuration data 210 from the MCS 25 to the electronic trading system 28 the data 210 will automatically be resent. On the other hand, if the status data 224 and the log data 222 indicate that the trade matching system 28 successfully received and loaded the configuration data 210, the MCS 25 publishes one of more files necessary for the configuration of other subsystems of the trade reporting and processing system 20 and places these files into a directory on the MCS 25 accessible by the other subsystems. Preferably, these files are made available via an intranet website, which is queried using an HTTP GET request and the status code returned in response to the request is checked to determine if a file is available.

The other subsystems that receive configuration files from the MCS 25 include the trade processing subsystem 22, the quote vendor subsystem 26, the audit data repository 84, and the exchange fee billing system 205. These subsystems poll the known directory on the MCS 25 for presence of their respective files, and retrieve and load the contents of the files when they become available.

### Intra-Day

As noted above, the MCS 25 may also transmit intra-day updates to the trade matching system 28 by creating and transmitting an additional transfer data file containing revised configuration data 210. Such intra-day updates may only modify a restricted number of items in the configuration data 210 sent at the start of the trading session. In a preferred embodiment, an intra-day update may only modify the ranges of prices within which specific products may trade. Alternatively, it should be apparent to one skilled in the art that an intra-day update may modify other data. These modifications may take effect immediately or may be deferred until the next trading day.

Once the transfer data file containing the revised configuration data 210 is created by the MCS 25, the transfer data file is transmitted to the trade matching system 28 in an identical fashion as was described above with respect to the start of day data.

Product and trader rights data are stored in product database 27. Trader rights indicate valid rights that a trader may have, such as the right to view and trade certain products and/or product groupings on one or more exchanges. The PPMS 24 provides an interface to product database 27, preferably Oracle Forms provided by Oracle of Redwood Shores, Calif., for creating, maintaining, and deleting data. The MCS 25 may also execute automated data maintenance and cleansing operations for certain fields at times specified by exchange operations staff. Examples of such operations include adding a holiday to the trading calendar, entering strike prices, adding new contracts, and modifying daily price limits.

### Membership Services Information System

As also seen in FIG. 2, the PPMS 24 includes a Membership Services Information System (MSIS) 216 to verify the trading eligibility of traders associated with badge ID's entered in the system. The MCS 25 interfaces with the MSIS 216 upon the attempted activation of a user ID for any trader. The MCS 25 verifies that the badge ID for a given user name of a trader corresponds to the badge ID and user name recorded in the MSIS 216 for the trader. The MCS 25 then checks the MSIS 216 to determine whether the trader has an existing Primary Clearing Member (PCM) relationship and further determines the trader has membership privilege. The membership privilege is true if either the trader leases a seat or owns at least one seat for which the trader has not leased out the complete set of trading privileges.

Should verification fail, the MCS 25 prevents activation of any user ID that coincides with the badge ID that failed the verification. The MCS 25 issues a user ID (allowing the trader to trade, but at customer rates) and then provides a meaningful message to the trader detailing the failure. The failure to activate is logged by the MCS 25.

The MCS 25 interfaces with the MSIS 216 at a pre-configurable time each session or multiple times per session.

### User Access Website

The PPMS includes a User Access Website (UAW) 226 that is used by an administrator at firm 74 to authorize new traders for trading on the trade matching systems 28 or to modify trader information. An administrator at firm 74 who wishes to authorize a new trader issues data 76 representing a new trader request to the UAW 226. The UAW 226 validates the data and transmits data 78 representing a trader update to the trade matching system 28. The UAW 226 also adds a record for the new trader into the LDAP directory server 214. The trade matching system 28 processes the trader update, creates a trader authorization file, and transmits the trader authorization data to the MCS file docking area 220. The trader authorization file contains a series of keys that are entered into the traders' electronic trading software that will allow the software to communicate with the trade matching system 28. The UAW allows the keys to be downloaded by the administrator at the firm 74. A notification, preferably in an electronic mail message, is then sent to all other administrators at the firm 74 indicating that the authorization file is ready to be downloaded.

### Reports

The MCS 24 furnishes reports on product data and trader data. Reports on specific sets of products are available. Detailed specification reports for each contract month of a single product are also available. The reports may be delivered to the exchange staff via email in HTML format, as is well known in the art, in spreadsheet format, or any other format.

User data reports including member mnemonic information are available. These reports may provide information for the trader associated with a member mnemonic including clearing mnemonic, the firm or group to which the trader belongs, the fee billing group, clearing status, ITM, etc. A user information list report is also available and may contain a user ID, the ITM's for which the trader is the responsible person, member mnemonic of the firm to which each ITM is assigned, security information (i.e., date of birth, city of birth, mother's maiden name), employer email address, badge ID, and contact information. In addition, an ITM report list is available and may include information concerning the member mnemonic and responsible person with which that ITM is associated, the user ID of the responsible person, the user ID of the backup of the responsible person, whether the trader identified by the member mnemonic has trading access, trading rights ID, history of trading access, security information of responsible person (i.e., date of birth, city of birth, mother's maiden name), and security information of a backup responsible person.

### Exchange Fee Billing System

An Exchange Fee Billing (EFB) system 205 provides trader information to clearinghouses to charge exchange fees on electronic trades. The MCS 25 of the PPMS 24 provides the necessary data files to the EFB system 205 on at least a daily basis. The MCS 25 provides a list of each user ID and the person ID (if any) to which each user ID corresponds. In addition, the MCS 25 provides the status (i.e., active or not active) of each user ID and the date that status of the user ID became effective. Preferably, the EFB system 205 receives data files one session later than other components of the trade processing and reporting system 20, as EFB system 205 does not require the information until transaction fees are to be billed.

The MCS 25 also provides to the EFB system 205 a list of each ITM, the single member mnemonic to which each ITM corresponds, the single person ID (if any) of the “responsible person” for that ITM, and the single firm ID that is associated with the member mnemonic. Further, the MCS 25 provides an access-enabled field of each ITM, and the date that the current value of the access enabled field became effective.

The EFB system 205 also receives from the MCS 25 data identifying a list of member mnemonics, a number of data fields that are associated with each member mnemonic (e.g., effective date, clearing member mnemonic, and clearing status), a line fee billing group associated with each member mnemonic, and the single firm ID that corresponds to each member mnemonic.

In a preferred embodiment, the EFB system 205 is implemented using a modified version of PeopleSoft Financials developed by PeopleSoft Inc. of Pleasanton, Calif.

### Audit Data Repository

A version of the configuration data sent to the trade matching system 28, comprising member mnemonics, trader mnemonics (ITMs), and product information, is sent once daily to the audit data repository 84 by the PPMS 24 prior to the end of the trading session for which the data applies. In addition, the MCS 24 provides a subset of user data and a subset of product data to the audit data repository 84.

### Market Data Handling Services

Like the trade processing subsystem 22, a Market Data Handling System (MDHS) 248 of the quote vendor subsystem 26 also receives an extract of the configuration data once daily. More specifically, product-based information necessary for translating raw ticks into exchange specific price formats for each product is provided by the PPMS 24 to the MDHS 248.

### II. Trade Processing Subsystem

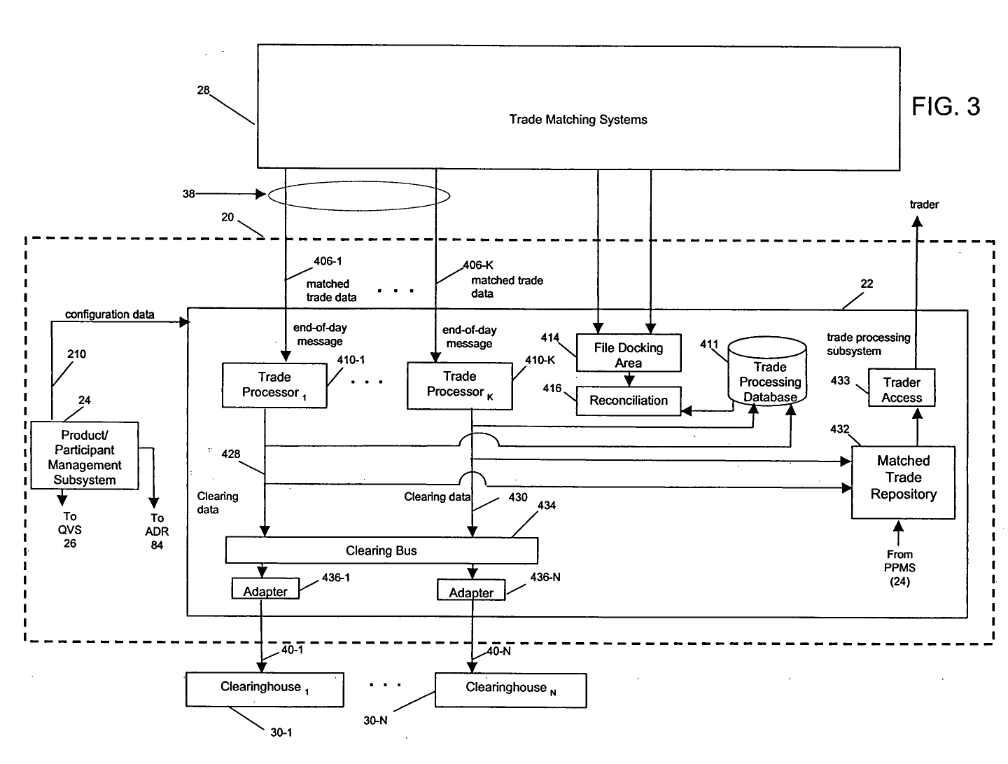

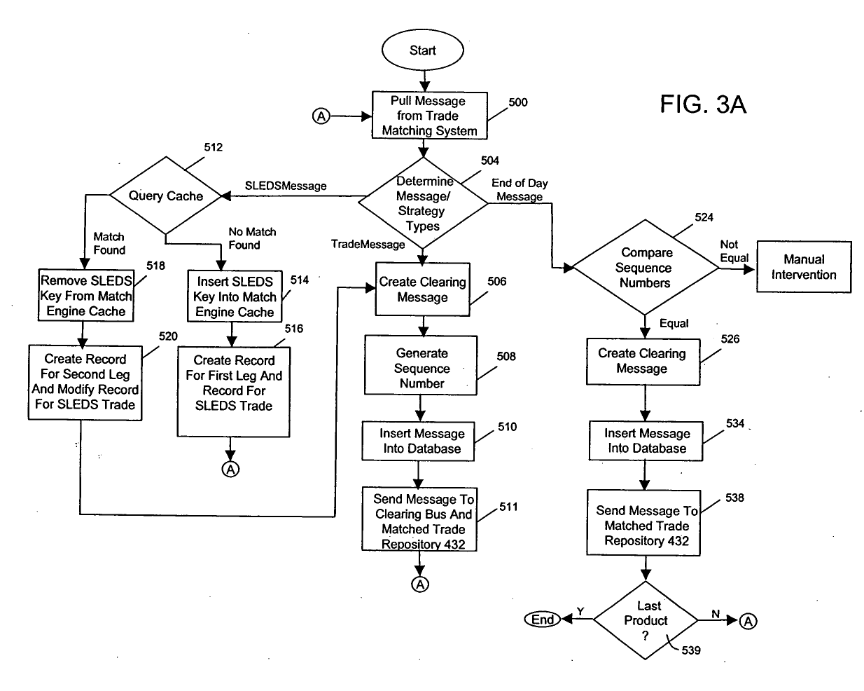

FIG. 3 illustrates the trade processing subsystem 22 of the present invention in greater detail. As noted above, the trade processing subsystem 22 is an interface between the trade matching system 28 and the clearinghouses 30-1 through 30-N. The matched trade data 38 of FIG. 1 are represented in FIG. 3 as multiple XML files or other data sets 406-1 through 406-K that are pulled in real time over multiple data channels from one or more queues provided within the trade matching system 28 to one or more trade processors 410-1 through 410-K in the trade processing subsystem 22 (where K is an integer). Multiple queues, channels and trade processors 410 are employed for load sharing purposes so that data are received in a prompt fashion. A queue may feed more than one trade processor; however, in the preferred embodiment, each trade processor 410 pulls data from only one queue. If desired, the data may instead be transmitted over a single channel to a single trade processor 410.

### Initialization

Just prior to the beginning of a trading day, the trade processors 410-1 through 410-K are initialized. In the preferred embodiment each trade processor 410-1 through 410-K represents a separate instance of a program for processing trades and the software implementing the program comprises a collection of Enterprise Java Beans running on a J2EE compliant application server provided by the WebLogic Platform™ from BEA Systems, Incorporated of San Jose, Calif. An administrator of the trade processing subsystem 22 manually prompts initialization. This, in turn, causes a number of procedures to be invoked including archiving of data, loading of a configuration file from the PPMS 24, and initialization of all components of the trade processors 410-1 through 410-K. Once these procedures are complete, the trade processors 410-1 through 410-K are ready to process inbound matched trade data 406-1 through 406-K, representing matched buy and sell orders, from the trade matching system 28.

Data archival includes the copying of all configuration-related data and log data previously stored in the trade processing database 411 to archive tables in the trade processing database 411 to prepare for the next trading day. After the data are archived, updated configuration data 210 are pulled from the PPMS 24 into the trade processing database 411. These data, in the form of multiple XML files, comprise a mapping of trade session counts, which are unique identifiers representing calendar days, to associated calendar days. These data are subsequently used to convert trade session counts from the trade matching system 28 to calendar dates for the matched trade data to be processed by the trade processors 410-1 through 410-K.

After the data are loaded into the trade processing database 411, message handlers, to be discussed later, read the data from the trade processing database and build a cache in memory representative of these data.

Component initialization is the last procedure required to complete the initialization of the trade processors 410-1 through 410-K. Once the data are archived and the updated configuration data 210 are loaded from the PPMS 24, the initialization procedure started by the system administrator informs a state manager within each trade processor 410-1 through 410-K that the trade processor may begin processing matched trade data. This prompts the delivery of initialization messages to all trade processors 410-1 through 410-K. Each component in the trade processors 410-1 through 410-K re-initializes with the new configuration data in preparation for the new trading day.

### Processing

After initialization, the trade processors 410-1 through 410-K are ready to convert matched trade data 406-1 through 406-K to clearing data. FIG. 3A illustrates a flow chart of programming executed by the trade processors 410-1 through 410-K to convert the matched trade data 406. Matched trade data 406-1 through 406-K in the form of Java Message Service (JMS) text messages are pulled from the trade matching system 28 at block 500. Each JMS text message comprises a message header and a message body. The message header contains a designation of the message as one of two overall message types: Trade and EndOfDay. The message body holds the contents of each message. The contents of each message comprise an embedded XML schema including a series of data fields representing matched trade data.

Each trade processor 410-1 through 410-K includes four message handlers: TradeMessageHandler, SLEDSMessageHandler, EndOfDayMessageHandler, and ShutdownMessageHandler. Each message handler is a process running on the trade processor 410, and is invoked either manually or when a message of a particular type is pulled from the trade matching system 28. Only one instance of each message handler is deployed within a single trade processor 410 in order to serially process the messages within each trade processor. Each message handler defines operations to be executed as described below.

At block 504, each trade processor 410-1 through 410-K retrieves the message type from the message header. If the overall type of the message received is Trade, the trade processor 410 determines the value of a “strategy type” field or portion of the message body. The strategy type field or portion represents a particular trading strategy. If the strategy type is “Reduced Tick Spread,” the SLEDSMessageHandler is invoked. For all other strategy types, the TradeMessageHandler is invoked. The TradeMessageHandler creates a clearing message at a block 506 in the form of a JMS text message. The message body of the JMS text message holds the contents of the message and is encoded in a specific format as required by a particular clearinghouse 30, such as an embedded M1 format. Data representing the message type and a clearinghouse code are added to a message header. The message type for these outbound messages will be either Clearing or EndOfDay. The clearinghouse code determines which clearinghouse 30-1 through 30-N the message is to be sent. Next, At block 508 the TradeMessageHandler retrieves a product message sequence number from the trade processing database 411 that corresponds to the product denoted in the received, increments the product message sequence number, appends product message sequence number to the message body of the clearing message, and updates the product message sequence number stored in the trade processing database 411. At the beginning of each trading day and for each product, the trade processing subsystem 22 resets the product message sequence number stored the trade processing database to 1.

After the matched trade data are converted, the resulting clearing message is stored at block 510 as data 428-1 through 428-K in the trade processing database 411 (FIG. 3). In addition, clearing messages having message types “Clearing” or “EndOfDay” are sent at a block 511 to a matched trade repository 432 of FIG. 3. Still further, clearing messages having the message type “Clearing” are published at the block 511 to a clearing bus 434 of FIG. 3. Control then returns to the block 500.

If the type of a received message is “Trade” and the strategy type is “Reduced Tick Spread,” the SLEDSMessageHandler is invoked. First, at a block 512 the SLEDSMessageHandler queries a cache that stores data including a reverse look-up key (i.e., Seller Id+Buyer Id) to determine if the message represents a new leg of a SLEDS trade. If no match is found, the message contains a new SLEDS leg. In this case, a SLEDS key is stored at a block 514 in the cache and two records are stored at a block 516 in a SLEDS table in the trade processing database 411. A first one of the two records includes data representing the first leg of the SLEDS trade and a second record includes data representing the SLEDS trade as a whole. Control then returns to the block 500.

If the cache returns a match, this indicates that the message includes data representing a second leg of a SLEDS trade. In this case, the SLEDS key is removed at a block 518 from the match engine cache. Further, a record is created at a block 520 including data representing the second leg of the SLEDS trade and the record is stored in the database 411. The SLEDSMessageHandler also modifies the record in the database 411 representing the SLEDS trade as a whole so that the fact that the second leg has been encountered is noted. Control then passes to the blocks 506-511 for generation of a clearing message in the form of a JMS text message in the appropriate format for both legs of the SLEDS trade. Thereafter, control returns to the block 500.

At the end of the trading day, a message having the message type “EndOfDay” is sent to each trade processor 410-1 through 410-K, thereby causing each trade processor to invoke the EndOfDayMessageHandler. Generally, an end of day message is received relative to each product. The message body contains the last trade matching message sequence number that is a count of the total number of trade messages for the product as sent by the trade matching system 28. The EndOfDayMessageHandler compares at a block 524 the last trade matching sequence number contained in the end of day message with the last product message sequence number stored in the trade processing database 411 for the associated product. If both sequence numbers are equal, then it has been determined that a valid end of trading day message has been received. If the sequence numbers are not equal, manual intervention is required. The EndOfDayMessageHandler then creates a clearing message at a block 526 in the form of a JMS text message encoded in the appropriate format including data representing an “EndOfDay” message type and a clearinghouse code. The clearing message is stored in the database 411 at a block 534 and the clearing message is sent to the matched trade repository 432 at a block 538. A determination is then made at a block 539 whether an end of day message has been received with respect to all traded products. If so, the process terminates. If not control returns to the block 500.

Referring again to FIG. 3, the trade matching system 28, at the end of the trading day, sends multiple history files 412-1 through 412-P containing matched trade data to a file docking area 414 within the trade processing subsystem 22. These data represent all matched buy and sell orders (e.g., trades) sent from the trade matching system 28 to the trade processing subsystem 22 during the trading day.

A reconciliation process 416 is also provided within the trade processing subsystem 22 to ensure all matched trade data included in the history files 412-1 through 412-P were processed by the trade processors 410. The matched trade data in the history files 412 are compared with the data stored in the trade processing database 411 to effect the reconciliation process. If reconciliation fails, the appropriate exchange personnel are alerted to undertake manual operations to resolve the conflict(s).

Although not shown, the ShutdownMessageHandler may be manually invoked by an administrator of the trade processing subsystem 22 to shut down the trade processors in a controlled fashion.

The matched trade repository 432 stores all pre-cleared matched trade data processed by the trade processors 410-1 through 410-K. A web-based application 433 may be provided for viewing persistent fill information from the matched trade repository 432. Traders may access the web-based application 433 to view their pre-cleared trade information.

Multiple adapters 436-1 through 436-N are provided within the trade processing subsystem 22. Specifically, one adapter is provided for each clearinghouse code. Each adapter monitors the clearing bus 434 and is responsive to a particular associated clearinghouse code. When a message is detected by an adapter that includes the clearinghouse code associated with the adapter, the adapter transmits the message via a queue to a particular clearinghouse 30. The particular clearinghouse 30 to which the message is sent is the designated clearing organization for the exchange identified by the clearinghouse code. When an adapter receives a message that includes a clearinghouse code other than the clearinghouse code associated therewith, the adapter ignores the message.

### III. Quote Vendor Subsystem

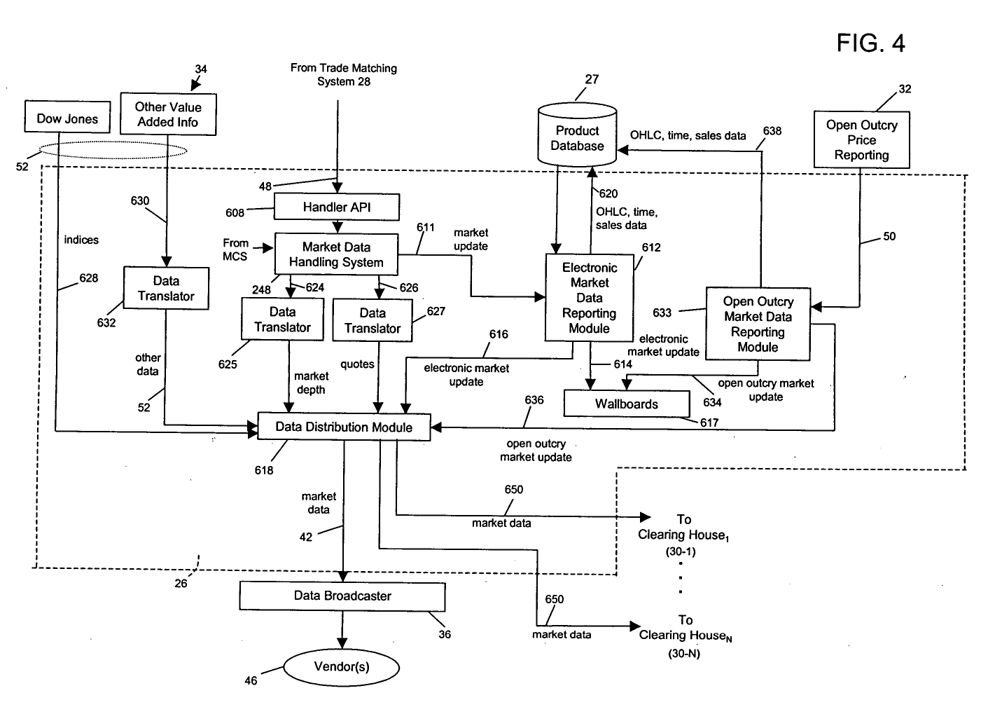

Referring to FIG. 4, an embodiment of the quote vendor subsystem (QVS) 26 is depicted. The QVS 26 includes a handler application program interface (“API”) 608 that is used by the MDHS 248 to obtain the real-time market data 48 from the trade matching system 28. The MDHS 248 also uses the handler API 608 to download configuration data, subscribe to appropriate markets, and receive market updates, market depth changes, settlements, indicative prices and deltas, volatilities, interest rates, and messages, such as updates on the state of various electronic markets. The MDHS 248 transmits data 611 representing market updates to an electronic market data reporting module 612 in a particular format hereinafter referred to as the “LAP format.” Examples of data 611 representing market updates include the price and quantity for best bids and offers (i.e., highest bids, lowest offers), the price, volume, and type of the last trade, settlements, cumulative volumes, etc. The LAP format utilizes a fixed length, ASCII text-based message. Table 1 provides an overview of the data fields incorporated in the LAP format:

TABLE 1
LAP Message Structure

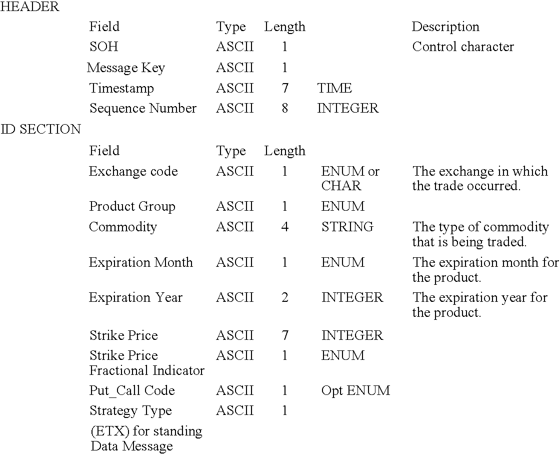

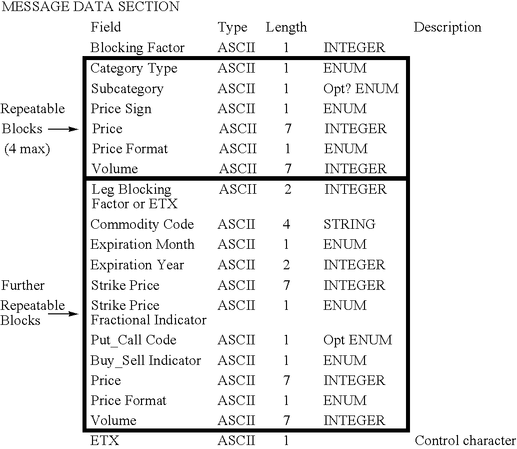

Once transmitted to the electronic trade reporting module 612, the data 611 representing market updates are converted from the LAP format to the Inter-Exchange Technical Committee (“ITC”) format. ITC is a well-known format to those skilled in the art and is used for transmitting market data and need not be described in detail herein. In addition to converting the data 611 representing market updates to ITC format, one or more further items of information (e.g., high price, low price) may be calculated by the electronic market data reporting module 612 and populated in the data 611 representing the market updates to create data 614, 616. For example, if the current daily high was 19 and the current daily low was 12 and a new market update (in LAP format) was received indicating a trade price of 20, a corresponding ITC message would be generated to establish the new daily high of 20.

The data 614, 616 are thereafter transmitted in to wallboards 617 and a data distribution module 618 (in ITC format), respectively. The wallboards 617 display price, quantity, etc. for use by open-outcry traders. The data 616 transmitted to the data distribution module 618 are disseminated, as described in greater detail below.

The electronic market data reporting module 612 creates different types of outgoing ITC messages depending on the type of updates received in LAP format. The outgoing ITC messages created by the market data reporting module 612, as discussed below, may conform to ITC Specification Version 2.1, which may be found at www.cbot.com/cbot/docs/52987.pdf. For example, if the data 611 is a first trade message, which is the first trade transacted during the current session for a product (e.g., contract or contract month), three output messages are created in ITC format. The first message is a “Category U” message, which includes an indicator signifying the market data reflects the opening price for the corresponding product for the current session. The second message created is a “Category O” message, which includes the best bid, ask, and trade prices, as well as the corresponding volumes, for the corresponding product for the current session. The last message created is a “Category H” message that includes high, low, and best prices for the corresponding product for the current session.

If the data 611 is a best bid/ask message, the electronic trade reporting module 612 stores the best bid and ask prices and corresponding volumes for the product in a cache. If the incoming best bid/ask message does not include the best bid/ask prices or the best bid/ask volumes, the electronic market data reporting module 612 populates this information before forwarding a “Category B” output message to the data distribution module 618.

Optionally, if the data 611 is in the form of a closing message for a product indicating that the current trading session has ended for the product, a “Category U” output message is created, which includes an indicator to identify this data as the closing price for the product.

If the data 611 are in the form of a trade message, two output messages are created by the electronic trade reporting module 612 for transmission to the data distribution module 618. The first message is a “Category O” message, which includes the best bid, ask, and trade prices and the corresponding volumes, and cumulative volumes. Before the message is transmitted, the electronic trade reporting module 612 stores the information for the appropriate product in a cache. Additionally, if an incoming message for a specific product causes the high or low price for that product to change, a “Category H” message is created, wherein the message includes the high, low, and last prices for the specified product.

In another scenario, if the data 611 representing market updates are in the form of a cumulative volume message for a particular product, a “Category V” message is created and transmitted to the data distribution module 618. The “Category V” message includes the cumulative volume for the particular product, which is a summation of all volumes traded for that product during a given session.

Still further, if the data 611 is in the form of a spread message, one of two types of messages is transmitted to the data distribution module 618. If the incoming message only contains bid and ask prices, a “Category B,” product classification “L” message is created and forwarded to the data distribution module 618. Otherwise, if the incoming message only contains trade prices, a “Category O,” product classification “L” message is created for transmission to the data distribution module 618.

On a daily basis, three different messages are generated by the electronic market data reporting module 612 and transmitted to the data distribution module 618 as data 616 representing market updates. The first two messages are “Category Z” messages that provide product specification details. The first of these messages is a “type D” message, which includes futures and options specifications. The other “Category Z” message is a “type 0” message, which includes option strike price specifications. The last messages sent from the electronic market data reporting module 612 are “Category J” messages, which include information for the various products (e.g. a final summary of open, high, low, close, settlement and/or volume).

Data 620 representing opening price, high price, low price, and closing price (“OHLC”) information, and cumulative volume information for all traded products are also transmitted from the electronic market data reporting module to a product database 27 (e.g., Oracle) using Oracle Call Library (OCL) connectivity. The data 620 may further include other data, such as time and sales, and settlement data, which are also forwarded to the product database 27 and are based on the data 611 representing market updates that are received by the electronic market data reporting module 612.

As the trade matching system 28 transmits market data 42, the MDHS 248 develops data 624 representing market depth. The data 624 are forwarded through a data translator 625, which converts the data from the market data API 48 to ITC format, to the data distribution module 618. Optionally, data 626 representing quotes (e.g., current best bid/offer price and volume, last trade price and volume, and cumulative volume) are simultaneously transmitted from the MDHS 248 through a data translator 627 in ITC format to the data distribution module 618.

Data 628 forming a part of the data 52 of FIG. 1 and representing indices from Dow Jones and/or other indices are also forwarded in ITC format from Dow Jones to the data distribution module 618. Additionally, any other data (e.g., other exchange data feeds) 630 (also forming a part of the data 52 of FIG. 1) from other external data sources 34 may optionally be transmitted to the data distribution module 618 through a data translator 632 that may convert the format of the data 630 into ITC format.

Data 50 representing open-outcry market data are transmitted in real-time by the open-outcry price reporting system 32 to an open-outcry market data reporting module 633. The open-outcry market data reporting module 633 collects all of the data from open-outcry trading and transmits data 634 representing open-outcry market updates to the wallboards 617. The open-outcry market data reporting module 633 also transmits data 636 representing open-outcry market updates in ITC format to the data distribution module 618. As with the data 620 supplied by the electronic market data reporting module 612, data 638 representing open outcry OHLC information, time and sales data, and settlement data are also transmitted to the product database 27.

The data distribution module 618 transmits continuously or periodically updated market data 42 to a data broadcaster 36, which thereafter broadcasts the market data via user datagram protocol (“UDP”) multicast groups to vendors 46 that are registered with the data broadcaster 36. One example of a data broadcaster is Radianz of New York, N.Y. The data distribution module 618 simultaneously transmits market data 650 to the clearinghouses 30-1 through 30-N via a Unicast connection using transmission control protocol (“TCP”). The clearinghouses 30-1 through 30-N use the market data 650 to reconcile the electronic market update data developed by the module 612 and the open-outcry market update data developed by the module 633 with the matched trades received from the trade matching system 28 and the open outcry environment, as discussed in detail above. It should be noted that the clearinghouse(s) 30-1 through 30-N may be external or internal to the processing and reporting system, as described herein.

Transaction Data Interface (“TDI”) software from CMS Webview™ may be utilized to implement the handler API 608, the MDHS 248, the data translators 625, 627, and 632, and/or the data distribution module 618. Generally, the TDI software provides the capability for certain data enrichment, such as merging multiple inbound channels into a single outbound channel, retransmissions, and administration of the system. Optionally, any other suitable software may be utilized for these implementations.

Preferably, the quote vendor subsystem 26 (and possibly other subsystems of the processing and reporting system), as described herein includes an enterprise-monitoring infrastructure (not shown) for monitoring system operations and for logging all system events and error messages. The purpose of such an infrastructure is to facilitate centralized monitoring and control of applications within the entire system or subsystem. Examples of software that could be implemented for systems monitoring are BMC Patrol from BMC Software, Inc. of Houston, Tex. and Topaz from Mercury Interactive of Mountain View, Calif.

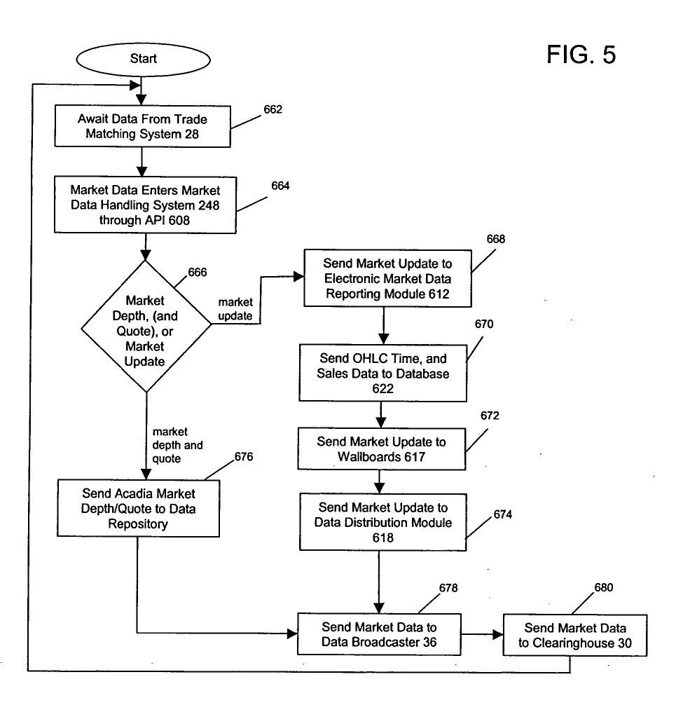

FIG. 5 illustrates a flowchart of programming executed by components of the quote vendor subsystem 26 of FIG. 4 to process messages received from the trade matching system 28. While the flowchart of FIG. 5 illustrates serial processes executed in a particular sequence, it should be understood that the subsystem 26 may undertake some or all of the processes in a different sequence order and/or may execute certain processes concurrently. At a block 662, the handler API 608 awaits the data 48 from the trade matching system 28. Once data 48 are received, the market data are transferred through the handler API 608 to the MDHS 248 at a block 664. The MDHS 248 then determines at a block 666 whether the received data represent market depth (and, optionally, quotes), or market updates. If the data represent market updates, the market updates are sent as the data 611 to the electronic market data reporting module 612 (block 668). After the electronic market data reporting module 612 manipulates the data as necessary, the data 620 representing OHLC prices and time and sales information are sent to the product database 27 at a block 670, the data 614 representing market updates are sent to the wallboards at a block 672 and the data 616 are sent to the data distribution module 618 at a block 674.

Referring back to the block 666, if the MDHS 248 determines that the data represent market depth or quotes, the data are transmitted to the data distribution module 618 at a block 676. As the data distribution module 618 is collecting market data in the form of market depth, quotes, and market updates, the market data 42 are transmitted to the data broadcaster at a block 678. In addition, the market data 650 are sent to the clearinghouses 30 at a block 680 via a Unicast connection using TCP. Control then returns to the block 662 to await further data. As noted above, the entire process depicted by FIG. 5 is undertaken in real-time, such that the market data received by vendors is up-to-date and accurate.

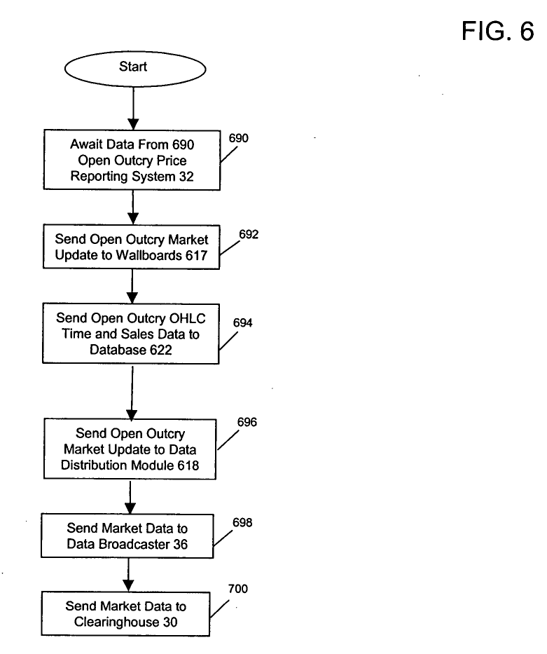

FIG. 6 illustrates a flowchart of programming executed by components of the quote vendor subsystem 26 to process messages received by the open-outcry system. As in the flowchart of FIG. 5, the flowchart of FIG. 6 illustrates serial processes executed in a particular sequence, it being understood that the subsystem 26 may undertake some or all of the processes in a different sequence order and/or may execute certain processes concurrently. At block 690, the open outcry market data reporting module awaits data from the open outcry price reporting system 32. Once data are received, data 634 representing open-outcry market updates are transmitted to the wallboards 617 at a block 692 and, at block 694, data 638 representing open-outcry OHLC prices, and time and sales are sent to the product database 27. Simultaneously, the data 636 representing open-outcry market updates are sent at a block 696 to the data distribution module 618. Data 42 representing open-outcry market updates, along with other market data such as data representing the electronic market updates transmitted by the block 678 of FIG. 5, and other data, are sent to the data broadcaster 36 at block 698 to be broadcast to vendors. The open outcry market data are sent as part of the data 650 to the clearinghouses 30.

While the incoming and outgoing data streams throughout the quote vendor subsystem 26 (as well as the incoming and outgoing data streams of other subsystems and components of the system 20) are illustrated by single lines, it should be understood that these lines may represent single or multiple data pathways, as desirable or necessary.

Preferably, the quote vendor subsystem 26 utilizes a VLAN 100 Mb routed network that links all of the internal components of the quote vendor subsystem 26.

The handler API 608 for market data is written using the C programming language. In order to provide flexibility, versions of the API are available for the following operating systems: Microsoft Windows 2000, utilizing Microsoft Visual C++ Compiler version 6.0 and Sun Solaris™ 8 for Unix, utilizing the 2.8 Forte C++6 Update 2 Compiler.

The MDHS 248 preferably is implemented by one server (e.g., a Sun server provided by Sun Microsystems of Santa Clara, Calif.) to handle the two feeds comprising market updates and the market depth/quotes. If desired, one or more servers could instead handle each feed. Also, each of the data distribution module 618 and the product database 27 is preferably implemented by a single server, but could instead be implemented by multiple servers, if desired.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A system for reporting and processing a matched trade from a market in response to orders submitted by traders, comprising:
a management subsystem for developing configuration data regarding products that are to be traded and traders who are authorized to trade;
a trade processing subsystem for receiving first data representing the matched trade and which processes the first data to create second data representing a processed trade wherein the second data are transmitted to a first recipient; and
a reporting subsystem for receiving market information and which processes the market information and transmits the processed market information to a second recipient.

2. The system of claim 1, wherein the trade processing subsystem transmits the second data to one of a plurality of clearinghouses selected based on the first or second data.

3. The system of claim 1, wherein the management subsystem is capable of sending start of day data at a start of a trading day regarding products that may be traded during the day and traders who are authorized to trade during the day.

4. The system of claim 1, wherein the management subsystem is capable of sending intra-day data after a start of a trading day regarding traders who are authorized after the start of the trading day to trade.

5. The system of claim 1, wherein the first recipient comprises a clearinghouse and in which the trade processing subsystem aggregates third data representing a plurality of matched trades into fourth data representing a single processed trade comprising a spread that is reported to the clearinghouse.

6. The system of claim 1, wherein the second recipient comprises a data broadcaster and wherein the reporting subsystem receives further market information from a non-electronic exchange, processes the further market information from the non-electronic exchange, and transmits the processed further market information to the second recipient.

7. The system of claim 1, wherein the reporting subsystem includes an electronic market data reporting module that receives market update data.

8. The system of claim 7, wherein the reporting subsystem further includes a data distribution module that receives electronic market update data from the electronic market data reporting module.

9. The system of claim 7, wherein the data distribution module further receives data representing a market condition from at least one external data source.

10. The system of claim 1, wherein the reporting subsystem further includes a handler application programming interface (API) that receives data representing matched trades, a market data handling system (MDHS) coupled to the handler API, and a data translator that translates the data representing the matched trades into messages that are sent to the second recipient.

11. The system of claim 10, wherein the data translator messages represent market depth.

12. The system of claim 11, further including an additional data translator responsive to the MDHS that develops additional messages representing market quotes.

13. The system of claim 1, wherein the trade processing subsystem includes at least one trade processor that converts data representing matched trades into clearing data.

14. The system of claim 13, wherein the clearing data are transmitted to a clearing bus.

15. The system of claim 14, wherein a plurality of clearinghouses receive clearing data and wherein the trade processing subsystem further includes a plurality of adapters coupled to the clearing bus that transmit the clearing data to the clearinghouses.

16. A computer implemented system for reporting and processing matched trades from a market in response to orders submitted by traders, comprising:
a trade processing subsystem including at least one trade processor that converts data representing matched trades into clearing data wherein the clearing data are transmitted to a clearing bus wherein the clearing data are transmitted to at least one of a plurality of clearinghouses; and
a reporting subsystem for receiving market information and which processes the market information and transmits the processed market information to a broadcaster.

17. The computer implemented system of claim 16, further including a management subsystem for sending start of day data at the start of each trading day regarding products that are to be traded during a trading day and traders who are authorized to trade during the trading day.

18. The computer implemented system of claim 16, in which the trade processing subsystem aggregates data representing a plurality of matched trades into data representing a single processed trade comprising a spread that is reported to the at least one clearinghouse.

19. The computer implemented system of claim 16, wherein the trade processing subsystem further includes a plurality of adapters coupled to the clearing bus that transmit the clearing data to the clearinghouses.

20. The computer implemented system of claim 16, wherein the reporting subsystem includes an electronic market data reporting module that receives market update data.

21. The computer implemented system of claim 20, wherein the reporting subsystem further includes a data distribution module that receives electronic market update data from the electronic market data reporting module.

22. The computer implemented system of claim 21, wherein the data distribution module further receives data representing a market condition from at least one external data source.

23. The computer implemented system of claim 16, wherein the reporting subsystem includes a handler application programming interface (API) that receives data representing matched trades, a market data handling system (MDHS) coupled to the handler API, and a data translator that translates the data representing the matched trades into messages that are sent to the broadcaster.

24. The computer implemented system of claim 23, wherein the data translator messages represent market depth.

25. The computer implemented system of claim 24, further including an additional data translator responsive to the MDHS that develops additional messages representing market quotes.

26. A computer implemented method of reporting and processing matched trades from a market in response to orders submitted by traders, the method comprising the steps of:
converting data representing matched trades into clearing data wherein the clearing data;
enabling transmission of clearing data to each of a plurality of clearinghouses;
transmitting the clearing data to at least one of the clearinghouses;
receiving data representing market information;
processing the market information to obtain market data; and
transmitting the processed market information to a broadcaster.

27. The computer implemented method of claim 26, further including the step of sending start of day data at the start of each trading day regarding products that are to be traded during a trading day and traders who are authorized to trade during the trading day.

28. The computer implemented method of claim 26, including the step of aggregating data representing a plurality of matched trades into data representing a single processed trade comprising a spread that is reported to the at least one clearinghouse.

29. The computer implemented method of claim 26, including the step of providing a clearing bus that receives the clearing data and further providing a plurality of adapters coupled to the clearing bus that transmit the clearing data to the clearinghouses.

30. The computer implemented method of claim 26, including the further step of providing an electronic market data reporting module that receives market update data.

31. The computer implemented method of claim 30, including the further step of providing a data distribution module that receives electronic market update data from the electronic market data reporting module.

32. The computer implemented method of claim 31, including the further step of providing data representing a market condition from at least one external data source to the data distribution module.

33. The computer implemented method of claim 26, including the further step of providing a handler application programming interface (API) that receives data representing matched trades, a market data handling system (MDHS) coupled to the handler API, and a data translator that translates the data representing the matched trades into messages that are sent to the broadcaster.

34. The computer implemented method of claim 33, wherein the data translator messages represent market depth.

35. The computer implemented method of claim 34, further including the step of providing an additional data translator responsive to the MDHS that develops additional messages representing market quotes.

36. A computer implemented method for processing and reporting information created in response to orders submitted to a market, the method comprising the steps of:
receiving trading data in a first format representing matched trades;
processing the trading data to develop clearing data in a second format representing the matched trades;
transmitting the clearing data to at least one of a plurality of clearinghouses;
developing market depth data and transmitting the market depth data to a data distribution module;
developing market update data from at least one of an electronic market and an open outcry market;
transmitting the market update data to the data distribution module; and
responsive to receipt of the market depth data and the market update data, causing the data distribution module to send processed market data to a broadcaster.

37. The computer implemented method of claim 36, including the further step of developing product/trader data representing products that are to be traded and traders who may trade.

38. The computer implemented method of claim 37, including the further step of transmitting the product/trader data prior to start of a trading day.

39. The computer implemented method of claim 38, comprising the further step of transmitting intra-day data identifying traders who have been newly authorized for trading after the start of a trading day.

40. The computer implemented method of claim 36, including the additional step of developing and transmitting clearing data representing a single processed trade by combining data representing a plurality of matched trades, wherein each matched trade is generated in response to orders matched for legs of a spread.

41. A computer implemented method of processing matched trade data, the method comprising the steps of:
receiving matched trade data representing a matched trade;
converting the matched trade data into a clearing message wherein the clearing message includes a clearinghouse code;
enabling communication with each of a plurality of clearinghouses; and
sending the clearing message to at least a selected one of the clearinghouses based upon the clearinghouse code.

42. The method of claim 41, further comprising the step of determining a type of the matched trade data.

43. The method of claim 42, wherein the step of determining comprises the step of ascertaining an overall message type and a strategy type denoted by a portion of the message and invoking one of a plurality of message handlers based on the ascertained types.

44. The method of claim 43, including the further step of processing the matched trade data using the invoked message handler.

45. The method of claim 44, wherein the plurality of message handlers includes a first message handler for processing matched trade data representing a certain type of spread and a second message handler for processing non-spread trades.

46. The method of claim 45, wherein the first message handler undertakes the steps of determining whether an association is found between the matched trade data and another set of matched trade data that was received at a prior time and, if the association is found, creating and storing a clearing message representing the certain type of spread.

47. The method of claim 46, wherein the step of determining whether the association is found comprises the step of querying a cache that stores data including a reverse look-up key.

48. The method of claim 47, wherein the first message handler undertakes the step of storing a reverse look-up key in the cache representing the matched trade data if the association is not found.

49. The method of claim 45, wherein the plurality of message handlers includes a third message handler for processing end of day messages.

50. A system for processing matched trade data, comprising:
means for receiving the matched trade data;
means for converting the matched trade data into a clearing message; and
means for sending the clearing message to one of multiple clearinghouses.

51. The system of claim 50, further comprising means for determining a type of the matched trade data.

52. The system of claim 50, wherein the converting means comprises at least one trade processor.

53. The system of claim 52, wherein the converting means comprises a plurality of trade processors.

54. The system of claim 52, wherein each trade processor includes means for ascertaining an overall type and a strategy type of the matched trade data and means for invoking one of a plurality of message handlers based on the ascertained types.

55. The system of claim 54 wherein the plurality of message handlers includes a first message handler for processing matched trade data representing a certain type of spread and a second message handler for processing non-spread trades.

56. The system of claim 55, wherein the first message handler includes means for determining whether an association is found between the matched trade data and another set of matched trade data that was received at a prior time and means responsive to the association determining means for creating and storing a clearing message representing the certain type of spread when the association is found.

57. The system of claim 56, wherein the association determining means comprises means for querying a cache that stores data including a reverse look-up key.

58. The system of claim 57, wherein the first message handler includes means for storing a reverse look-up key in the cache representing the matched trade data if the association is not found.

59. The system of claim 55, wherein the plurality of message handlers includes a third message handler for processing end of day messages.

60. The system of claim 50, further comprising means for storing the clearing message.
